(19) United States
(12) Patent Application Publication
(10) Pub. No.: US 2020/0004268 A1
(43) Pub. Date: Jan. 2, 2020

(54) METHOD AND APPARATUS FOR DETERMINING VALIDITY OF MESSAGE RECEIVED BY VEHICLE IN AUTOMATED VEHICLE & HIGHWAY SYSTEMS

(71) Applicant: LG Electronics Inc., Seoul (KR)

(72) Inventor: Yongsoo PARK, Seoul (KR)

(21) Appl. No.: 16/557,932

(22) Filed: Aug. 30, 2019

(30) Foreign Application Priority Data
Jul. 31, 2019 (KR) 10-2019-0093511

(51) Int. Cl. G05D 1/02; G01C 21/32; G06K 9/00; B60W 30/18; B60W 30/095

(52) U.S. Cl. CPC G05D 1/0276; G05D 1/024; G05D 1/0289; G01C 21/32; B60W 2550/402; B60W 30/18154; B60W 30/0956; G06K 9/00825; G06K 9/00798; G06K 9/00805

(57) ABSTRACT

In automated vehicle & highway systems, status information of an intersection where a first vehicle tries to enter and a Signal Phase and Timing (SPaT) message are received, a traveling route of the first vehicle is set on a High-Definition (HD) map generated using the intersection status information, lane information having the same lane status as that of a travel lane of the first vehicle is acquired based on the intersection status information and the SPaT message, and a first validity determination for determining whether the intersection status information and the SPaT message are valid is executed based on the lane information and the HD map. Accordingly, a validity of the received message can be determined. The present invention is associated with an artificial intelligence module, an unmmanned aerial vehicle (UAV) robot, an augmented reality (AR) device, a virtual reality (VR) device, and a device related to a 5G service.

### CROSS-REFERENCE TO RELATED APPLICATIONS

This application claims the benefit of Korean Application No. 10-2019-0093511, filed on Jul. 31, 2019. The contents of this application are hereby incorporated by reference in its entirety.

### BACKGROUND OF THE INVENTION

### Field of the Invention

The present invention relates to automated vehicle & highway systems, and particularly, a method and an apparatus for determining a validity of a Map data message and a Signal Phase and Timing (SPat) message received by a vehicle.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

The present invention suggests a method for determining a validity of a Map data message and a Signal Phase and Timing (SPaT) message received by a vehicle.

The present invention also suggests a method of determining the validity of the Map data message and the Signal Phase and Timing (SPaT) message received by the vehicle and executing a control operation according to a result value.

Technical objects to be solved by the present invention are not limited to the technical objects mentioned above, and other technical objects that are not mentioned will be apparent to a person skilled in the art from the following detailed description of the invention.

In an aspect, a method for determining a validity of a message received by a first vehicle in automated vehicle & highway systems is provided. The method includes receiving status information on an intersection where the first vehicle tries to enter and a Signal Phase and Timing (SPaT) message, setting a traveling route of the first vehicle on a High-Definition (HD) map generated using the intersection status information, acquiring lane information having the same lane status as that of a travel lane of the first vehicle based on the intersection status information and the SPaT message, and executing a first validity determination for determining whether the intersection status information and the SPaT message are valid based on the lane information and the HD map. The intersection status information includes center point position information of the intersection, entry lane information of the intersection, and exit lane information of the intersection, the lane status indicates a traffic light signal, and the first validity determination is based on a collision risk between a second vehicle traveling a lane having the same lane status and the first vehicle.

When a result value of the first validity determination indicates a validity, the intersection status information and the SPaT message may be used in an application of the first vehicle.

When a result value of the first validity determination indicates an invalidity, a low-speed traveling may be executed to prevent the collision risk.

The method may further include executing a second validity determination for determining whether the intersection status information and the SPaT message are valid based on sensing data acquired through a sensor of the first vehicle, and the first vehicle may enter the intersection.

The second validity determination may be based on whether an actual travel status of the second vehicle acquired using the sensing data and a prediction travel status of the second vehicle predicted using the intersection status information and the SPaT message coincide with each other.

The method may further include executing a second validity determination for determining whether the intersection status information and the SPaT message are valid based on sensing data acquired through a sensor of the first vehicle, and the first vehicle may enter the intersection.

The second validity determination may be based on whether a signal of a traffic light device of the intersection acquired using the sensing data and a traffic light signal predicted using the intersection status information and the SPaT message coincide with each other.

When a result value of the second validity determination indicates a validity, the first vehicle may maintain the low-speed traveling.

When a result value of the second validity determination indicates a validity, the first vehicle may transmit a valid message indicating that the intersection status information and the SPaT message are valid.

When a result value of the second validity determination indicates an invalidity, the first vehicle may execute an emergency speed control, set a sensing level for monitoring the lane having the same lane status, and transmit a warning message indicating the collision risk.

The executing of the first validity determination may be based on whether, using an array constituted by rows and columns corresponding to the entry lane information of the intersection, a first number of the array mapped to the traveling route of the first vehicle and a second number of the array mapped to an entry lane of the intersection coincide with each other.

When the first vehicle enters a preset constant distance from a center point of the intersection and does not receive the intersection status information and the SPaT message, the first vehicle may execute a low-speed traveling to prevent the collision risk.

In another aspect, a first vehicle for determining a validity of a message received from automated vehicle & highway systems is provided. The vehicle includes a sensor, a communication module, a memory, and a processor. The processor receives intersection status information and a Signal Phase and Timing (SPaT) message related to an intersection where the first vehicle tries to enter through the communication module, sets a traveling route of the first vehicle on a High-Definition (HD) map generated using the intersection status information, acquires lane information having the same lane status as that of a travel lane of the first vehicle based on the intersection status information and the SPaT message, and executes a first validity determination for determining whether the intersection status information and the SPaT message are valid based on the lane information and the HD map, and the intersection status information includes center point position information of the intersection, entry lane information of the intersection, and exit lane information of the intersection, the lane status indicates a traffic light signal, and the first validity determination is based on a collision risk between a second vehicle traveling a lane having the same lane status and the first vehicle.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 shows a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram referred to describe a usage scenario of a user according to an embodiment of the present invention.

FIG. 10 is an example of V2X communication to which the present invention is applicable.

FIGS. 11A and 11B show a resource allocation method in a side-link where the V2X is used.

FIG. 12 is an embodiment to which the present invention is applicable.

FIG. 13 is an embodiment to which the present invention is applicable.

FIG. 14 is an embodiment to which the present invention is applicable.

FIG. 15 is an example of an HD map generation to which the present invention is applicable.

FIG. 16 is an example of a first validity determination method to which the present invention is applicable.

FIG. 17 is an example of a second validity determination method to which the present invention is applicable.

FIG. 18 is a diagram showing a configuration of a server to which the present invention is applied.

The accompanying drawings, which are included as a part of detailed descriptions to aid understanding of the present invention, provide an embodiment of the present invention and, together with the detailed description, explain technical features of the present invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

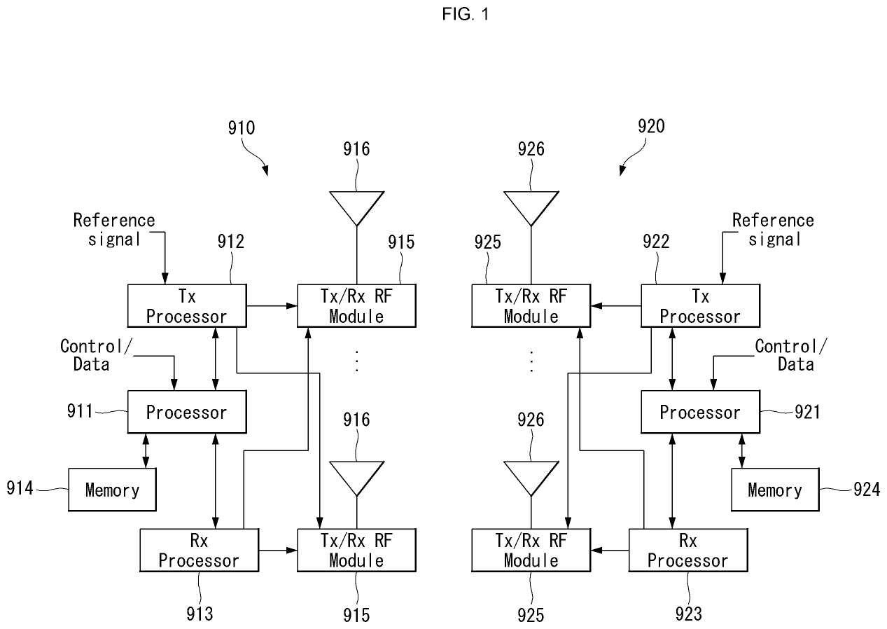

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

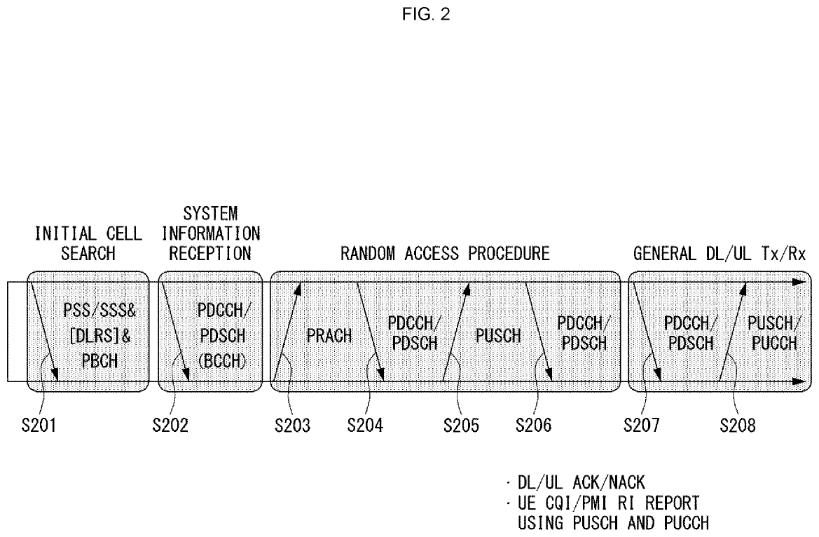

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent path loss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘cssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

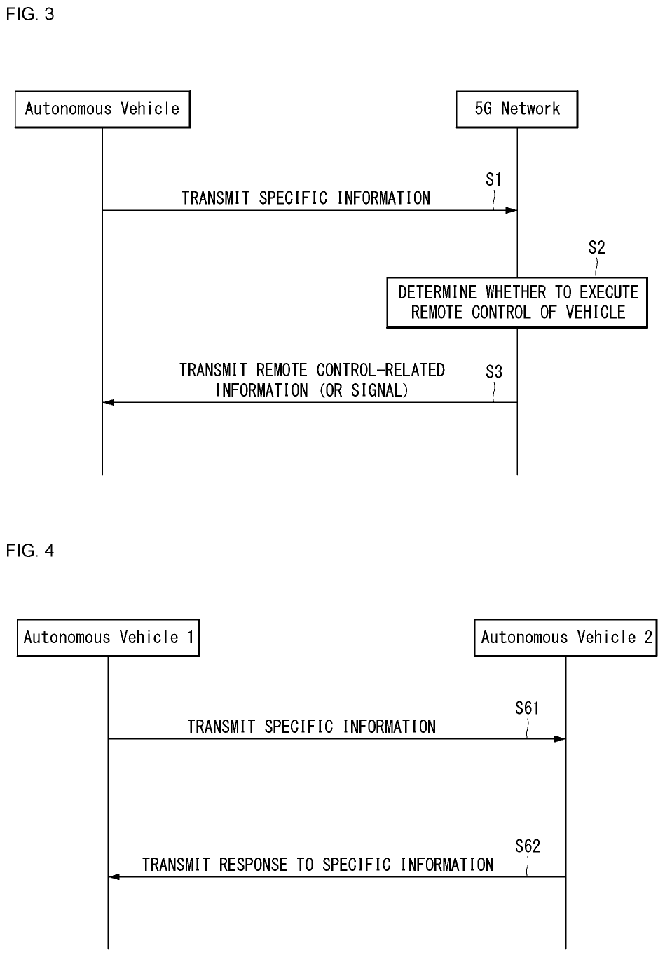

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2).

Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61. The second vehicle transmits a response to the specific information to the first vehicle (S62).

Meanwhile, a configuration of an applied operation between vehicles may depend on whether the 5G network is directly (side-link communication transmission mode 3) or indirectly (side-link communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical side-link control channel (PSCCH) is a 5G physical channel for scheduling of transmission of specific information a physical side-link shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

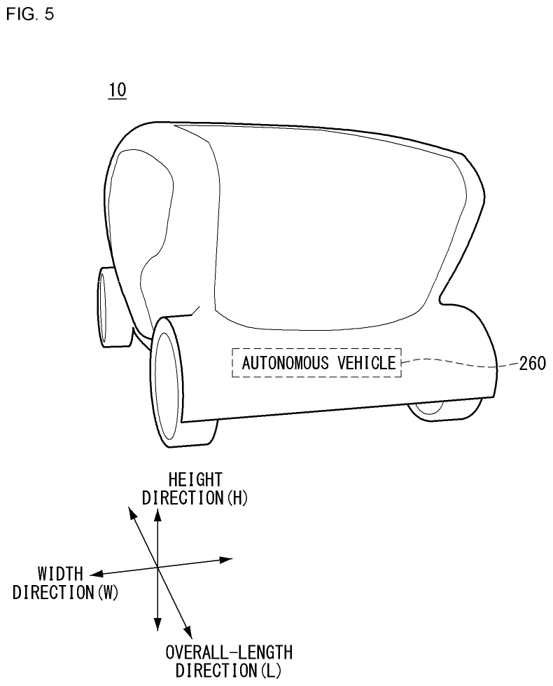

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

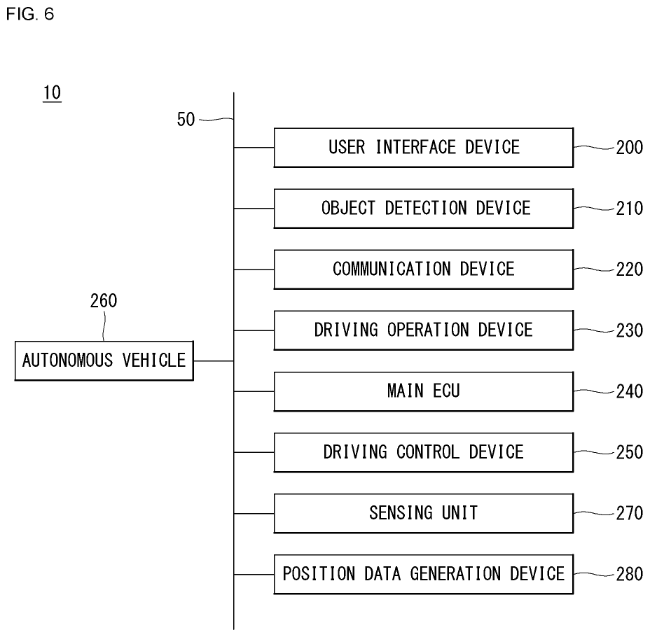

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensor 270, and a position data generation device 280. The object detection device 210, the communication device 220, the driving operation device 230, the main ECU 240, the driving control device 250, the autonomous device 260, the sensor 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include side-link communication based on LTE and/or side-link communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensor

The sensor 270 can detect a state of the vehicle. The sensor 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensor 270 can generate vehicle state data on the basis of a signal generated from at least one sensor. Vehicle state data may be information generated on the basis of data detected by various sensors included in the vehicle. The sensor 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensor 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

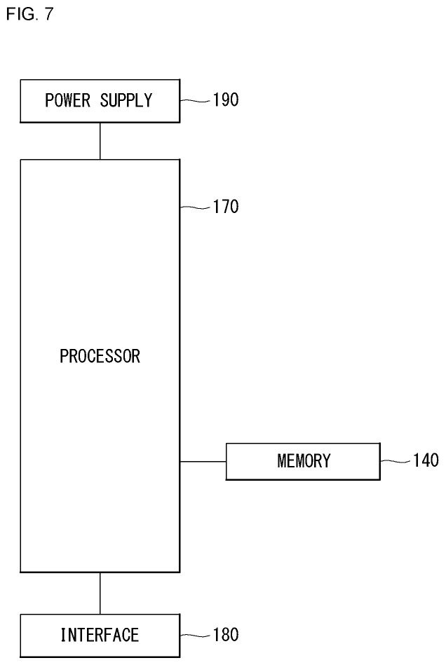

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensor 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

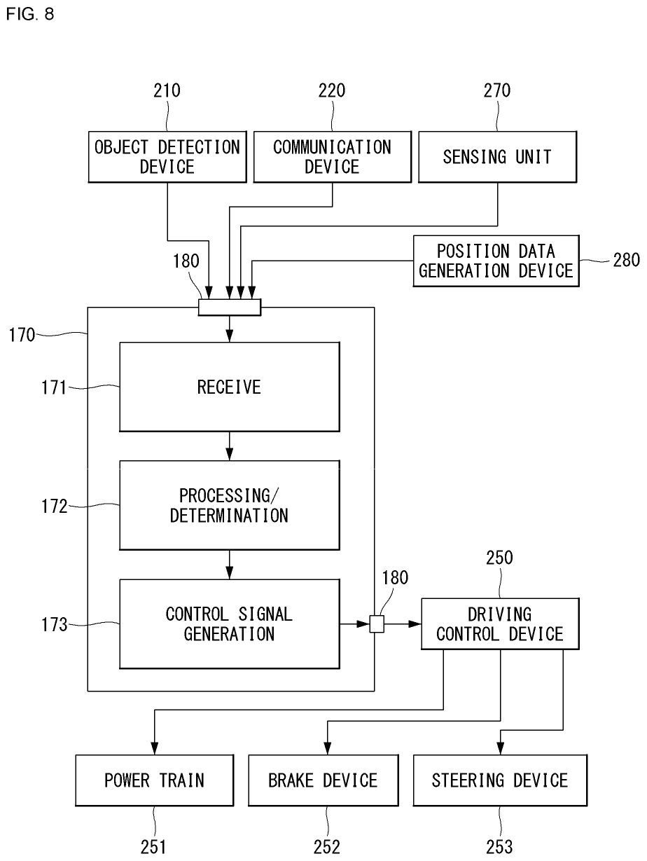

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensor 270 and the position data generation device 280 through the interface 180. The processor 170 can receive object data from the object detection device 210. The processor 170 can receive HD map data from the communication device 220. The processor 170 can receive vehicle state data from the sensor 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 253.

Autonomous Vehicle Usage Scenario

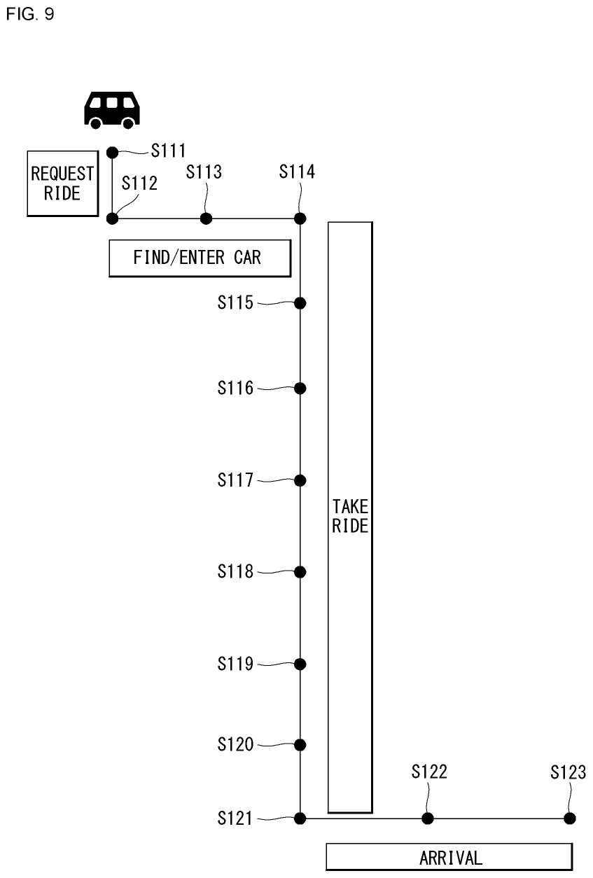

FIG. 9 is a diagram referred to describe a usage scenario of the user according to an embodiment of the present invention.

1) Destination Forecast Scenario

A first scenario S111 is a destination forecast scenario of the user. A user terminal may install an application that can be linked with a cabin system 300. The user terminal can forecast the destination of the user through the application based on user's contextual information. The user terminal may provide vacant seat information in a cabin through the application.

2) Cabin interior layout countermeasure scenario

A second scenario S112 is a cabin interior layout countermeasure scenario. The cabin system 300 may further include a scanning device for acquiring data on the user located outside a vehicle 300. The scanning device scans the user and can obtain physical data and baggage data of the user. The physical data and baggage data of the user can be used to set the layout. The physical data of the user can be used for user authentication. The scanning device can include at least one image sensor. The image sensor can use light in a visible light band or an infrared band to acquire an image of the user.

The seat system 360 can set the layout in the cabin based on at least one of the physical data and baggage data of the user. For example, the seat system 360 may provide a baggage loading space or a seat installation space.

3) User Welcome Scenario

A third scenario S113 is a user welcome scenario. The cabin system 300 may further include at least one guide light. The guide light may be disposed on a floor in the cabin. The cabin system 300 may output the guide light such that the user is seated on the seat, which is already set among the plurality of sheets when user's boarding is detected. For example, a main controller 370 may implement moving light through sequential lighting of a plurality of light sources according to the time from an open door to a predetermined user seat.

4) Seat Adjustment Service Scenario

A fourth scenario S114 is a seat adjustment service scenario. The seat system 360 may adjust at least one element of the seat that matches the user based on the acquired physical information.

5) Personal Content Provision Scenario

A fifth scenario S115 is a personal content provision scenario. A display system 350 can receive personal data of the user via an input device 310 or a communication device 330. The display system 350 can provide a content corresponding to the personal data of the user.

6) Product Provision Scenario

A sixth scenario S116 is a product provision scenario. A cargo system 355 can receive user data through the input device 310 or the communication device 330. The user data may include preference data of the user and destination data of the user. The cargo system 355 may provide a product based on the user data.

7) Payment Scenario

A seventh scenario S117 is a payment scenario. A payment system 365 can receive data for price calculation from at least one of the input device 310, the communication device 330 and the cargo system 355. The payment system 365 can calculate a vehicle usage price of the user based on the received data. The payment system 365 can require the user (that is, mobile terminal of user) to pay a fee at the calculated price.

8) User Display System Control Scenario

An eighth scenario S118 is a user display system control scenario. The input device 310 may receive a user input configured in at least one form and may convert the user input into an electrical signal. The display system 350 can control a content displayed based on the electrical signal.

9) A1 Agent Scenario

A ninth scenario S119 is a multi-channel artificial intelligence (Al) agent scenario for multiple users. An A1 agent 372 can distinguish the user input of each of multiple users. The A1 agent 372 can control at least one of the display system 350, the cargo system 355, the seat system 360, and the payment system 365 based on the electric signal converted from the user input of each of the multiple users.

10) Multimedia Content Provision Scenario for Multiple Users

A tenth scenario S120 is a multimedia content provision scenario for multiple users. The display system 350 can provide a content that all users can view together. In this case, the display system 350 can individually provide the same sound to multiple users through a speaker provided in each sheet. The display system 350 can provide a content that the multiple users individually can view. In this case, the display system 350 can provide an individual sound through the speaker provided in each sheet.

11) User Safety Securing Scenario

An eleventh scenario S121 is a user safety securing scenario. When vehicle peripheral object information that poses a threat to the user is acquired, the main controller 370 can control to output an alarm of the vehicle peripheral object via the display system 350.

12) Belongings Loss Prevention Scenario

A twelfth scenario S122 is a scenario for preventing loss of belongings of the user. The main controller 370 can obtain data on the belongings of the user via the input device 310. The main controller 370 can obtain user motion data through the input device 310. The main controller 370 can determine whether the user places the belongings and gets off based on the data of the belongings and the motion data. The main controller 370 can control to output an alarm of the belongings through the display system 350.

13) Get Off Report Scenario

A thirteenth scenario S123 is a get off report scenario. The main controller 370 can receive get off data of the user through the input device 310. After the user gets off, the main controller 370 can provide report data for the get off to the mobile terminal of the user through the communication device 330. The report data may include the entire usage fee data of the vehicle 10.

Vehicle-to-Everything (V2X)

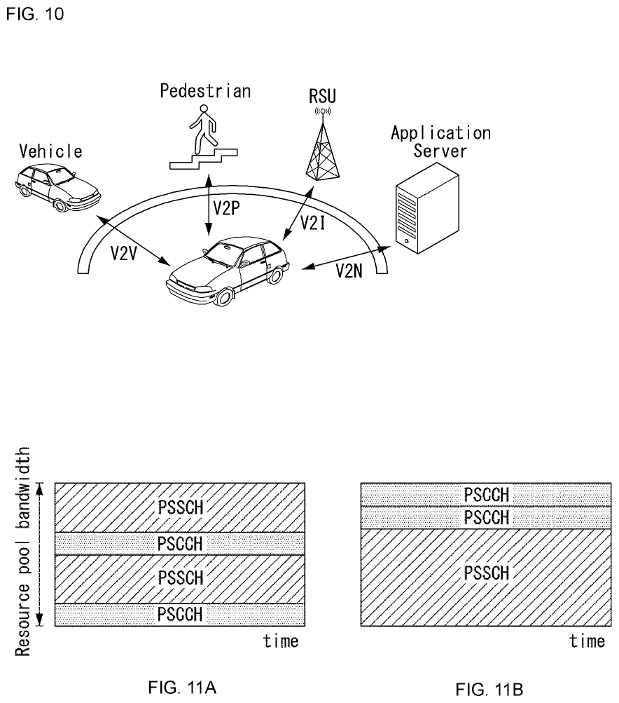

FIG. 10 is an example of V2X communication to which the present invention is applicable.

The V2X communication includes communication between a vehicle and all objects such as Vehicle-to-Vehicle (V2V) referring to communication between vehicles, Vehicle-to-Infrastructure (V2I) referring to communication between a vehicle and an eNB or a Road Side Unit (RSU), and Vehicle-to-Pedestrian (V2P) or a Vehicle-to-Network (V2N) referring to communication between a vehicle and a UE with an individual (pedestrian, bicycler, vehicle driver, or passenger).

The V2X communication may indicate the same meaning as V2X side-link or NR V2X, or may include a broader meaning including the V2X side-link or NR V2X.

For example, the V2X communication can be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication can be provided via a PC5 interface and/or a Uu interface. In this case, in a wireless communication system that supports the V2X communication, there may exist a specific network entity for supporting the communication between the vehicle and all the objects. For example, the network object may be a BS (eNB), the road side unit (RSU), a UE, an application server (for example, a traffic safety server), or the like.

In addition, the UE executing V2X communication includes not only a general handheld UE but also a vehicle UE (V-UE), a pedestrian UE, a BS type (eNB type) RSU, a UE type RSU, a robot having a communication module, or the like.

The V2X communication may be executed directly between UEs or may be executed through the network object(s). V2X operation modes can be divided according to a method of executing the V2X communication.

The V2X communication requires a support for UE pseudonymity and privacy when a V2X application is used so that an operator or a third party cannot track a UE identifier within a V2X support area.

Terms frequently used in the V2X communication are defined as follows.

Road Side Unit (RSU): The RSU is a V2X serviceable device that can perform transmission/reception with a moving vehicle using a V2I service. Furthermore, the RSU can exchange messages with other entities supporting the V2X application as a fixed infrastructure entity supporting the V2X application. The RSU is a term often used in the existing ITS specifications, and a reason for introducing this term in 3GPP specifications is to make it easy to read a document in an ITS industry.

The RSU is a logical entity that combines a V2X application logic with functions of a BS (referred to as BS-type RSU) or a UE (referred to as UE-type RSU).

V2I service: A type of V2X service in which one is a vehicle and the other is an entity belongs to an infrastructure.

V2P service: A type of the V2X service in which one is a vehicle and the other is a device (for example, handheld UE carried by pedestrian, bicycler, driver, or passenger) carried by an individual.

V2X service: A 3GPP communication service type in which a transmitting or receiving device is related to a vehicle.

V2X enabled UE: A UE supporting the V2X service.

V2V service: A type of the V2X service in which both in the communication are vehicles.

V2V communication range: A range of direct communication between two vehicles participating in the V2V service.

As described above, the V2X application referred to as the V2X (Vehicle-to-Everything) includes four types such as (1) Vehicle-to-Vehicle (V2V), (2) Vehicle-to-infrastructure (V2I), (3) Vehicle-to-Network (V2N), and (4) Vehicle-to-Pedestrian (V2P).

FIGS. 11A and 11B show a resource allocation method in a side-link where the V2X is used.

In the side-link, different physical side-link control channels (PSCCHs) may be separately allocated in a frequency domain, and different physical side-link shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP release 14 and 15, supports for the V2V and V2X services are introduced in LTE.

Requirement for supports with respect to an enhanced V2X use case are broadly divided into four use case groups.

(1) A Vehicle Platooning can dynamically form a platoon in which vehicles move together. All vehicles in the platoon get information from the top vehicle to manage this platoon. These pieces of information allow the vehicles to be operated in harmony in the normal direction and to travel together in the same direction.

(2) Extended sensors can exchange raw data or processed data collected by a local sensor or a live video image in a vehicle, a road site unit, a pedestrian device, and a V2X application server. In the vehicle, it is possible to raise environmental awareness beyond what a sensor in the vehicle can sense, and to ascertain broadly and collectively a local situation. A high data transmission rate is one of main features.

(3) Advanced driving allows semi-automatic or full-automatic driving. Each vehicle and/or the RSU shares own recognition data obtained from the local sensor with a proximity vehicle and allows the vehicle to synchronize and coordinate a trajectory or maneuver. Each vehicle shares a driving intention with the proximity vehicle.

(4) Remote driving allows a remote driver or the V2X application to drive the remote vehicle for a passenger who cannot drive the remote vehicle in his own or in a dangerous environment. If variability is restrictive and a path can be forecasted as public transportation, it is possible to use Cloud computing based driving. High reliability and a short waiting time are important requirements.

The above-described 5G communication technology can be combined with methods proposed in the present invention which will be described later and applied or can complement the methods proposed in the present invention to make technical features of the methods concrete and clear.

Hereinafter, embodiments of the disclosure will be described in detail with reference to the attached drawings.

In general, a North American V2X standard referred to as 5.8 GHz dedicated short range communication (DSRC) is established by IEEE (IEEE 802.11p, IEEE 1609) which is a standardization organization in electrical/electronic field and SAE (SAE J2735, SAE J2945, or the like) which is a meeting of vehicle engineers, which are responsible for standardization of a physical layer and a SW stack standardization and an application layer standardization, respectively.

In particular, with respect to message standards, SAE has established a standard for defining message specifications for the V2X communication. Enactment and revise of this standard are still executed, and currently, SAE J2735-2016, which was released in 2016, is used. In the present invention, various embodiments will be described with reference to the SAE J2735-2016.

Intersection Signal Violation Warning Service

In order to receive an intersection signal violation warning service, a vehicle traveling an intersection receives a Signal Phase and Timing (SPaT) message having information format for linking a traffic light signal, spatial information, positioning correction information, or the like, a Map data message, or the like, from the server, using the RSU or the like.

1. Signal Phase and Timing (SPaT) Message

A message specification, which is provided in the vehicle or the like traveling the intersection through the RSU, follows a SPaT information format standard. The following table 1 is an example of a SPaT message set. The SPaT message provides status information with respect to all lanes of the intersection. The SPaT message may include, in addition to the example of Table 1, various information including priority ranking information of the lane, or signal information of the vehicles approaching each lane at the intersection.

TABLE 1

| Signal Phase and Timing | | Explanation | Remark |
|---|---|---|---|
| msgID | | Message ID | |
| name | | Intersection name | |
| id | | Intersection ID | |
| status | | Intersection | Manual operation |
| | | signal status | Signal stop |
| | | | Automatic |
| | | | operation |
| MovementStates | currState | Current signal | |
| | | status | |
| | pedState | Pedestrian signal | |
| | | status | |
| | timetoChange | Signal remaining | |
| | | time | |

In Table 1, the currState may indicate a phase status of the traffic light signal.

Table 2 is an example of a phase status of the traffic light signal.

TABLE 2

| | Phase Status | | |
|---|---|---|---|
| | Green Phase | Yellow Phase | Red Phase |
| record | Lane State | | |
| 1 | Right turn yellow | Right turn yellow | Right turn red signal |
| | flashing signal | signal | |
| 2 | Blue signal | Yellow signal | Red signal |
| 3 | Right turn blue | Right turn yellow | Right turn red signal |
| | signal | signal | |
| 4 | Left turn yellow | Left turn yellow | Left turn red signal |
| | flashing signal | signal | |
| 5 | Left turn blue | Left turn yellow | Left turn red signal |
| | signal | signal | |
| 6 | Left turn red signal | Left turn red signal | Left turn red signal |
| . . . | . . . | . . . | . . . |

2. Map Data Message

The message specification provided to the vehicle or the like traveling the intersection through the RSU follows a Map data message information format specification. The following Table 3 is an example of a Map data message set. The Map data message may include various information in addition to the example of Table 3.

TABLE 3

| Map data | | | | Explanation |
|---|---|---|---|---|
| magID | | | | Message ID |
| name | | | | Intersection name |
| id | | | | Intersection ID |
| ref Point | latitude | | | Intersection center |
| | | | | point latitude |
| | longitude | | | Intersection center |
| | | | | point longitude |
| | elevation | | | Intersection center |
| | | | | point elevation |
| orientation | | | | Intersection direction |
| approaches | ref Point | latitude | | Intersection approach |
| | | | | point latitude |
| | | longitude | | Intersection approach |
| | | | | point longitude |
| | | elevation | | Intersection approach |
| | | | | point elevation |
| | lane Width | | | Lane width |
| | approach | driving | lane | Approach lane number |
| | | Lanes | Number | |
| | | | lane | Lane attribute |
| | | | Attributes | |
| | | | Offsets | Coordinate offset |
| | egress | driving | lane | Egress number |
| | | Lanes | number | |
| | | | lane | Lane attribute |
| | | | Attributes | |
| | | | Offsets | Coordinate offset |

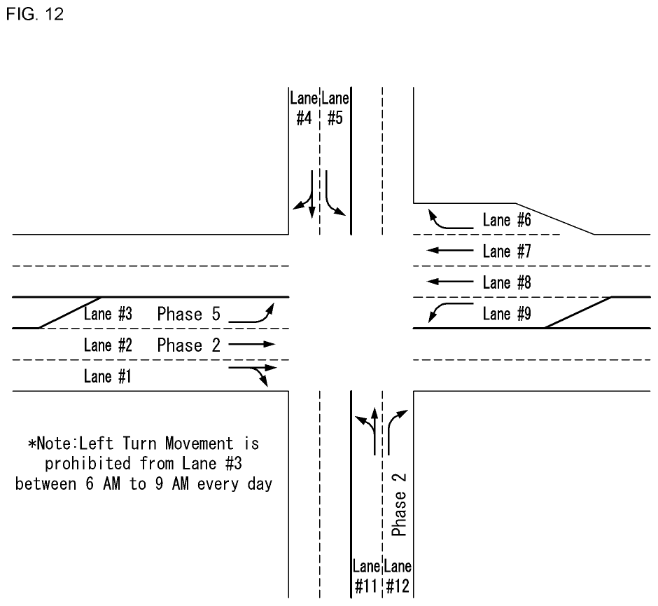

FIG. 12 is an embodiment to which the present invention is applicable.

With reference to FIG. 12, the vehicle can generate Map information using the Map data message and the SPaT message. Traffic light signal phase information extracted from the SPaT message is mapped to the lane of the intersection generated based on the Map data message, and the vehicle traveling the lane can know a time when the vehicle can enter the intersection. For example, with reference to Table 2, fifth phase information is mapped in a third lane, and second phase information is mapped in a second lane. Accordingly, in a case where a phase status is a green phase, while a left turn travel is permitted to the vehicle of the third lane, a straight travel is permitted to the vehicle of the second lane. In addition, a right turn travel is permitted to the vehicle of a tenth lane.

An intersection signal violation warning service may be provided according to the similar method.

The present invention suggests a method for determining a validity of a signal transmitted from the RSU in the intersection signal violation warning service.

In the related art, the determination of the validity using an angle of the signal transmitted from the RSU can be used when the signal has properties of Lane-of-Sight. However, when the signal does not have the properties of Lane-of-Sight, there is a problem that the determination of the validity is difficult.

With respect to an attack through false information using the V2X, since the ID of a transmission device is not constantly maintained and there is on subject to catch the attack, a countermeasure to the attack is weak. Particularly, when the attack occurs in the intersection having a complicated road section or the like, it is expected that a problem caused by the attack is more serious.

When the false information is included in the Signal Phase and Timing (SPaT) transmitted using the V2I, a possibility of an accident increases.

Accordingly, for example, the present invention suggests the following method.

1. The vehicle receives the SPaT message and a MAP data message using a V2I message.

2. In the SPaT message and the MAP message, information on another lane having a collision possibility is extracted from a high definition (HD) map.

3. When it is determined that the vehicle may collide with a vehicle of the lane through the information on another lane, the vehicle generates a warning message.

4. When it is determined that the SPaT message is a false message, a warning message is transmitted to the server and other vehicles through the network.

Accordingly, when an attacker attacks with the false message, it is possible to ascertain the attack and prevent a collision at the intersection. Moreover, it is possible to prevent the collision at the intersection caused by the V2I message including error information.

In the present invention, the vehicle receives the SPaT message and the MAP message and extracts a traffic light signal of own lane by a combination of the two messages. Information of lanes permitting a simultaneous intersection entrance is extracted based on the traffic light signal of the own lane. The vehicle generates own traveling route on the HD map. The vehicle determines whether the own traveling route and a traveling route of a vehicle traveling another lane permitting a traveling simultaneous with the own traveling are the same as each other. Accordingly, when it is determined that there is a possibility of a collision, the SPaT message is determined to be a message which is not valid, and thus, is not used. Information on the message determined to be not valid is transmitted to other vehicles together with a warning message.

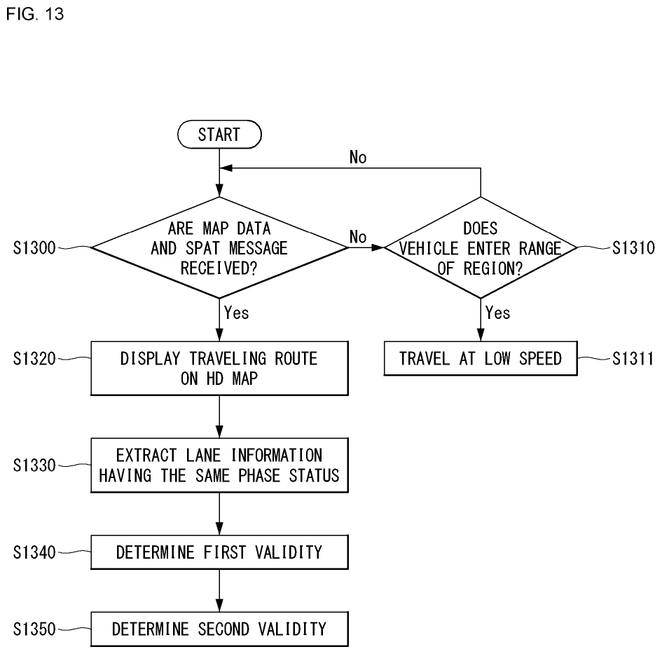

FIG. 13 is an embodiment to which the present invention is applicable.

When the vehicle enters a predetermined distance range (for example, within 500 m) with reference to a center point of the intersection, it is determined whether the vehicle receives MAP data/SPaT message (S1300).

When the vehicle does not receive the MAP data/SPaT message, it is determined whether the vehicle enters a range of a region expected to receive the messages (S1310). For example, a range of this region may be within 100 m from the center point of the intersection. When the vehicle does not enter the range of the region, the vehicle can still expect to receive the messages, and thus, the vehicle receives the MAP data/SPaT message again.

If the vehicle does not receive the messages even when the vehicle enter the range of the region, the vehicle cannot expect to receive the MAP data/SPaT message at the intersection, the vehicle maintains a preset speed and can enter the intersection (S1311). The preset speed may be set to a low speed which is sufficient for a safe traveling of the vehicle.

When the vehicle receives the MAP data/SPaT message, the vehicle displays the own traveling route on the HD map indicating the intersection (S1320).

Using the received MAP data/SPaT message, the vehicle extracts information of a lane having the same phase status as that of the lane along which the own vehicle travels (S1330). This lane may be set to a lane with a risk of a collision.

The own traveling route and the traveling route of the vehicle traveling other lanes are compared with each other based on the lane formation to execute a first validity determination (S1340).

When the vehicle enters the intersection, the vehicle senses a traffic light device, vehicle travel information, or the like through a sensor, and can execute a second validity determination of the MAP data/SPaT message (S1350).

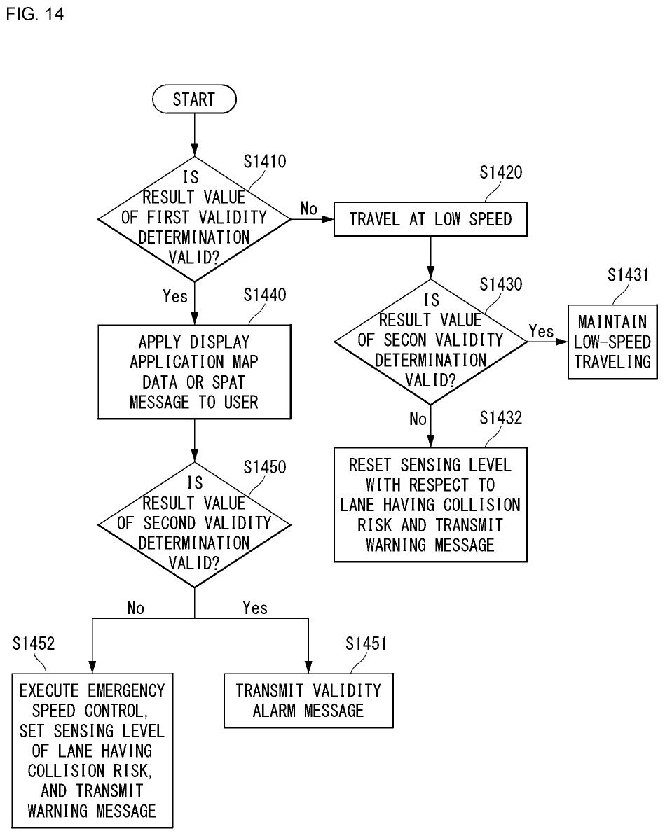

FIG. 14 is an embodiment to which the present invention is applicable.

FIG. 14 shows an embodiment with respect to the first validity determination and the second validity determination.

The vehicle determines whether a result value of the first validity determination is valid (S1410).

When the result value of the first validity determination is not valid, the vehicle changes a traveling speed value to a preset speed which is sufficiently low for safely traveling (S1420).

The vehicle entering the intersection determines whether a result value of the second validity determination is valid (S1430).

When the result value of the second validity determination is valid, the vehicle maintains a low-speed traveling (S1431).

When the result value of the second validity determination is not valid, the vehicle sets a sensing level with respect to a lane with a risk of a collision to a high level and transmits a warning message to prevent the collision (S1432).

If the result value of the first validity determination is valid, the vehicle may display information related to the received message to the user, and the information can be applied to an application such as a Red Light Violation Warning, an Eco-Drive, a Green Light Optimized Speed Advisory (GLOSA), or the like (S1440) using the received message and the information related to the receive message.

The vehicle entering the intersection determines whether the result value of the second validity is valid (S1450).

When the result value of the second validity is valid, the vehicle transmits a valid message indicating that the MAP data/SPaT message is valid (S1451).

When the result value of the second validity is not valid, the vehicle executes an emergency speed control, the vehicle sets the sensing level with respect to the lane with a risk of a collision to a high level and transmits a warning message to prevent the collision (S1452).

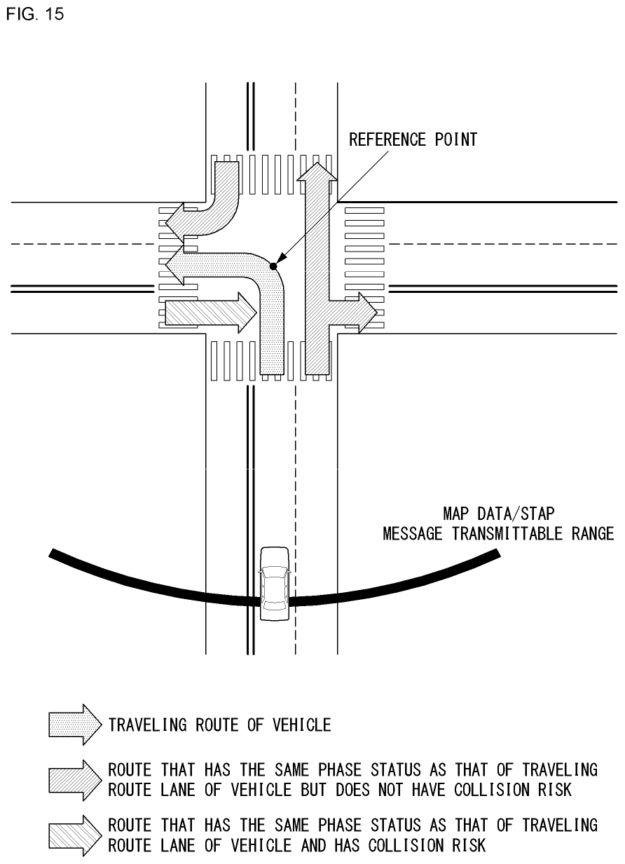

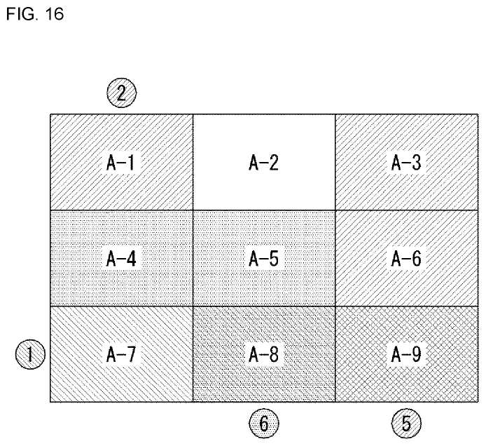

FIG. 15 is an example of a HD map generation to which the present invention is applicable.

If the vehicle receives the MAP data/STaP message, the vehicle can determine a traveling route of a lane having the same phase status as that of the own traveling route based on the HD map.

FIG. 16 is an example of a first validity determination method to which the present invention is applicable.

With reference to FIG. 16, the first validity determination method based on the embodiment of FIG. 15 is as follows.

The intersection has a 3×3 array having rows and columns in an entry lane. Based on the HD map, the vehicle can map the own traveling route and the traveling route of the lane having the same phase status as that of the own traveling route by an array corresponding to the number of lanes entering the intersection.

For example, the vehicle may be mapped to A-4, A-5, and A-8 based on own traveling route information. In a case of a second lane having the same phase status, the vehicle may be mapped to A-1, and in a case of a fifth lane, the vehicle may be mapped to A-3, A-6, and A-9. Since a first lane is a straight traveling lane, the vehicle may be mapped to A-7, A-8, and A-9. In a case of a lane having the same array number as an array number corresponding to the own traveling route information, it is determined that collision occurs. Accordingly, the vehicle can determine the first validity.

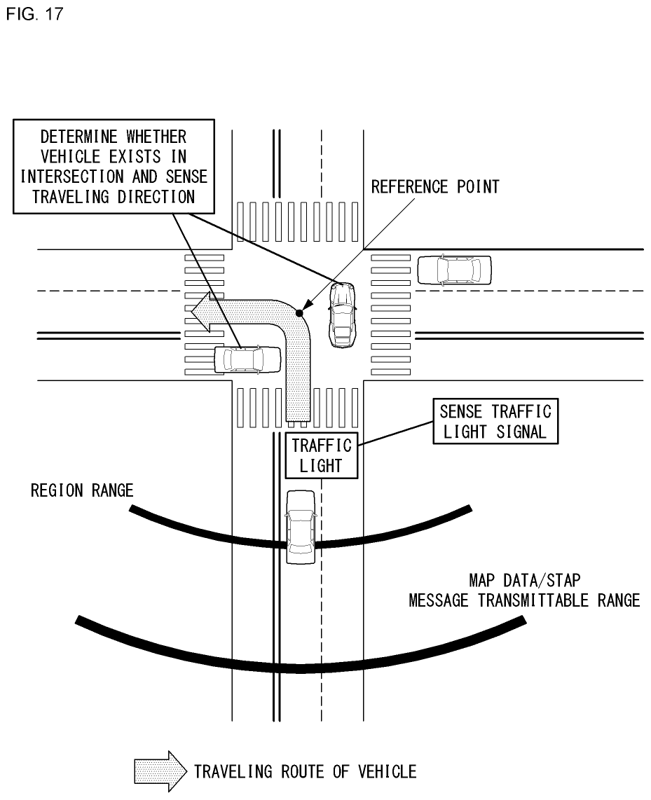

FIG. 17 is an example of a second validity determination method to which the present invention is applicable.

The vehicle senses the traffic light, travel information of other vehicles, or the like through a sensor and determines the second validity.

When the traffic light signal determined through sensing data and the traffic light signal acquired through the MAP/SPaT message do not coincide with each other for a predetermined time (for example, one second) or more, the vehicle may determine that the MAP/SPaT message is not valid.

When a travel status of the vehicle in the sensed intersection and travel statuses of other vehicles based on the MAP/SPaT message do not coincide with each other, it is determined that the MAP/SPaT message is not valid.

Device to which present invention is applicable

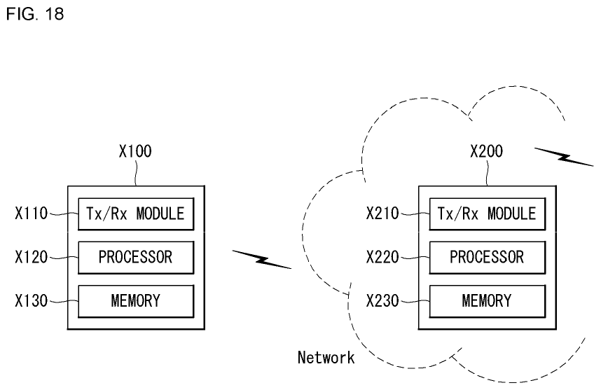

Referring to FIG. 18, a server X200 according to a proposed embodiment may be the MEC server or the Cloud server, and may include a communication module X210, a processor X220 and a memory X230. The communication module X210 is also referred to as a radio frequency (RF) unit. The communication module X210 can be configured to transmit various signals, data, and information to an external device, and to receive various signals, data, and information from the external device. The server X200 can be connected to the external device in wired and/or wireless manner. The communication module X210 can be implemented to be divided into a transmission unit and a receiving unit. The processor X220 can control all operations of the server X200, and the server X200 can be configured to execute a function of computing information or the like to be transmitted and received to and from the external device. In addition, the processor X220 can be configured to execute a server operation provided by the present invention. The processor X220 can control the communication module X210 to transmit data or a messages to the UE, other vehicles, or other servers based on a proposal of the present invention. The memory X230 can save arithmetically processed information or the like during a specified period of time, and can be replaced with a component such as a buffer.

Moreover, the specific configurations of the terminal device X100 and the server X200 as described above can be implemented such that contents described in various embodiments of the above-described present invention are independently applied or two or more embodiments are applied at the same time, and the overlapping contents are omitted for clarity.

Embodiment to which present invention is applicable

### Embodiment 1

A method for determining a validity of a message received by a first vehicle in automated vehicle & highway systems, the method including: receiving status information on an intersection where the first vehicle tries to enter and a Signal Phase and Timing (SPaT) message; setting a traveling route of the first vehicle on a High-Definition (HD) map generated using the intersection status information; acquiring lane information having the same lane status as that of a travel lane of the first vehicle based on the intersection status information and the SPaT message; and executing a first validity determination for determining whether the intersection status information and the SPaT message are valid based on the lane information and the HD map, in which the intersection status information includes center point position information of the intersection, entry lane information of the intersection, and exit lane information of the intersection, the lane status indicates a traffic light signal, and the first validity determination is based on a collision risk between a second vehicle traveling a lane having the same lane status and the first vehicle.

### Embodiment 2

In Embodiment 1, when a result value of the first validity determination indicates a validity, the intersection status information and the SPaT message are used in an application of the first vehicle.

### Embodiment 3

In Embodiment 1, the method further includes executing a low-speed traveling to prevent the collision risk when a result value of the first validity determination indicates an invalidity.

### Embodiment 4

In Embodiment 1, the method further includes executing a second validity determination for determining whether the intersection status information and the SPaT message are valid based on sensing data acquired through a sensor of the first vehicle, in which the first vehicle enters the intersection.

### Embodiment 5

In Embodiment 4, the second validity determination is based on whether an actual travel status of the second vehicle acquired using the sensing data and a prediction travel status of the second vehicle predicted using the intersection status information and the SPaT message coincide with each other.

### Embodiment 6

In Embodiment 3, the method further includes executing a second validity determination for determining whether the intersection status information and the SPaT message are valid based on sensing data acquired through a sensor of the first vehicle, in which the first vehicle enters the intersection.

### Embodiment 7

In Embodiment 6, the second validity determination is based on whether a signal of a traffic light device of the intersection acquired using the sensing data and a traffic light signal predicted using the intersection status information and the SPaT message coincide with each other.

### Embodiment 8

In Embodiment 6, when a result value of the second validity determination indicates a validity, the first vehicle maintains the low-speed traveling.

### Embodiment 9

In Embodiment 4, when a result value of the second validity determination indicates a validity, the first vehicle transmits a valid message indicating that the intersection status information and the SPaT message are valid.

### Embodiment 10

In Embodiment 4, when a result value of the second validity determination indicates an invalidity, the first vehicle executes an emergency speed control, sets a sensing level for monitoring the lane having the same lane status, and transmits a warning message indicating the collision risk.

### Embodiment 11

In Embodiment 1, the executing of the first validity determination is based on whether, using an array constituted by rows and columns corresponding to the entry lane information of the intersection, a first number of the array mapped to the traveling route of the first vehicle and a second number of the array mapped to an entry lane of the intersection coincide with each other.

### Embodiment 12

In Embodiment 1, when the first vehicle enters a preset constant distance from a center point of the intersection and does not receive the intersection status information and the SPaT message, the first vehicle executes a low-speed traveling to prevent the collision risk.

### Embodiment 13

A first vehicle for determining a validity of a message received from automated vehicle & highway systems, the first vehicle including: a sensor; a communication module; a memory; and a processor, in which the processor receives intersection status information and a Signal Phase and Timing (SPaT) message related to an intersection where the first vehicle tries to enter through the communication module, sets a traveling route of the first vehicle on a High-Definition (HD) map generated using the intersection status information, acquires lane information having the same lane status as that of a travel lane of the first vehicle based on the intersection status information and the SPaT message, and executes a first validity determination for determining whether the intersection status information and the SPaT message are valid based on the lane information and the HD map, and the intersection status information includes center point position information of the intersection, entry lane information of the intersection, and exit lane information of the intersection, the lane status indicates a traffic light signal, and the first validity determination is based on a collision risk between a second vehicle traveling a lane having the same lane status and the first vehicle.

### Embodiment 14

In Embodiment 13, when a result value of the first validity determination indicates a validity, the processor uses the intersection status information and the SPaT message in an application of the first vehicle.

### Embodiment 15

In Embodiment 13, when a result value of the first validity determination indicates an invalidity, the processor executes a low-speed traveling to prevent the collision risk.

### Embodiment 16

In Embodiment 13, the processor executes a second validity determination for determining whether the intersection status information and the SPaT message are valid based on sensing data acquired through the sensor, and the first vehicle enters the intersection.

### Embodiment 17

In Embodiment 16, the second validity determination is based on whether an actual travel status of the second vehicle acquired using the sensing data and a prediction travel status of the second vehicle predicted using the intersection status information and the SPaT message coincide with each other.

### Embodiment 18

In Embodiment 15, the processor executes a second validity determination for determining whether the intersection status information and the SPaT message are valid based on sensing data acquired through a sensor of the first vehicle, and the first vehicle enters the intersection.

### Embodiment 19

In Embodiment 18, the second validity determination is based on whether a signal of a traffic light device of the intersection acquired using the sensing data and a traffic light signal predicted using the intersection status information and the SPaT message coincide with each other.

### Embodiment 20

In Embodiment 18, when a result value of the second validity determination indicates a validity, the first vehicle maintains the low-speed traveling.

### Embodiment 21

Embodiment 4, when a result value of the second validity determination indicates a validity, the first vehicle transmits a valid message indicating that the intersection status information and the SPaT message are valid.

### Embodiment 22

In Embodiment 16, when a result value of the second validity determination indicates an invalidity, the first vehicle executes an emergency speed control, sets a sensing level for monitoring the lane having the same lane status, and transmits a warning message indicating the collision risk.

### Embodiment 23

Embodiment 13, the processor executes the determination based on whether, using an array constituted by rows and columns corresponding to the entry lane information of the intersection, a first number of the array mapped to the traveling route of the first vehicle and a second number of the array mapped to an entry lane of the intersection coincide with each other.

### Embodiment 24

In Embodiment 13, when the first vehicle enters a preset constant distance from a center point of the intersection and does not receive the intersection status information and the SPaT message, the processor executes a low-speed traveling to prevent the collision risk.

The above-described present invention can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present invention without departing from the spirit or scope of the invention described in the appended claims. For example, each component described in detail in embodiments can be modified. In addition, differences related to such modifications and applications should be interpreted as being included in the scope of the present invention defined by the appended claims.

The present invention is described with reference to the example applied to the automated vehicle & highway systems based on the 5G (5 generation) system. However, the present invention can be applied to various wireless communication systems and autonomous traveling devices.

According to an embodiment of the present invention, the vehicle can determine the validities of the received Map data message and Signal Phase and Timing (SPaT) message in the automated vehicle & highway systems.

In addition, according to an embodiment of the present invention, the vehicle can determine the validities of the received Map data message and Signal Phase and Timing (SPaT) message in the automated vehicle & highway systems and can execute a control operation according to the result values of the determination.

Effects obtained in the present invention are not limited to the effects mentioned above, and other effects not mentioned can be clearly understood by a person skilled in the art from the above descriptions.

What is claimed is:

1. A method for determining a validity of a message received by a first vehicle in automated vehicle & highway systems, the method comprising:
receiving status information on an intersection where the first vehicle tries to enter and a Signal Phase and Timing (SPaT) message;
setting a traveling route of the first vehicle on a High-Definition (HD) map generated using the intersection status information;
acquiring lane information having the same lane status as that of a travel lane of the first vehicle based on the intersection status information and the SPaT message; and
executing a first validity determination for determining whether the intersection status information and the SPaT message are valid based on the lane information and the HD map, wherein
the intersection status information includes center point position information of the intersection, entry lane information of the intersection, and exit lane information of the intersection, the lane status indicates a traffic light signal, and the first validity determination is based on a collision risk between a second vehicle traveling a lane having the same lane status and the first vehicle.

2. The method of claim 1, wherein when a result value of the first validity determination indicates a validity, the intersection status information and the SPaT message are used in an application of the first vehicle.

3. The method of claim 1, further comprising:
executing a low-speed traveling to prevent the collision risk when a result value of the first validity determination indicates an invalidity.

4. The method of claim 1, further comprising:
executing a second validity determination for determining whether the intersection status information and the SPaT message are valid based on sensing data acquired through a sensor of the first vehicle, wherein
the first vehicle enters the intersection.

5. The method of claim 4, wherein the second validity determination is based on whether an actual travel status of the second vehicle acquired using the sensing data and a prediction travel status of the second vehicle predicted using the intersection status information and the SPaT message coincide with each other.

6. The method of claim 3, further comprising:
executing a second validity determination for determining whether the intersection status information and the SPaT message are valid based on sensing data acquired through a sensor of the first vehicle, wherein
the first vehicle enters the intersection.

7. The method of claim 6, wherein the second validity determination is based on whether a signal of a traffic light device of the intersection acquired using the sensing data and a traffic light signal predicted using the intersection status information and the SPaT message coincide with each other.

8. The method of claim 6, wherein when a result value of the second validity determination indicates a validity, the first vehicle maintains the low-speed traveling.

9. The method of claim 4, wherein when a result value of the second validity determination indicates a validity, the first vehicle transmits a valid message indicating that the intersection status information and the SPaT message are valid.

10. The method of claim 4, wherein when a result value of the second validity determination indicates an invalidity, the first vehicle executes an emergency speed control, sets a sensing level for monitoring the lane having the same lane status, and transmits a warning message indicating the collision risk.

11. The method of claim 1, wherein the executing of the first validity determination is based on whether, using an array constituted by rows and columns corresponding to the entry lane information of the intersection, a first number of the array mapped to the traveling route of the first vehicle and a second number of the array mapped to an entry lane of the intersection coincide with each other.

12. The method of claim 1, wherein when the first vehicle enters a preset constant distance from a center point of the intersection and does not receive the intersection status information and the SPaT message, the first vehicle executes a low-speed traveling to prevent the collision risk.

13. A first vehicle for determining a validity of a message received from automated vehicle & highway systems, the first vehicle comprising:
a sensor;
a transceiver;
a memory; and
a processor, wherein
the processor receives intersection status information and a Signal Phase and Timing (SPaT) message related to an intersection where the first vehicle tries to enter through the transceiver, sets a traveling route of the first vehicle on a High-Definition (HD) map generated using the intersection status information, acquires lane information having the same lane status as that of a travel lane of the first vehicle based on the intersection status information and the SPaT message, and executes a first validity determination for determining whether the intersection status information and the SPaT message are valid based on the lane information and the HD map, and
the intersection status information includes center point position information of the intersection, entry lane information of the intersection, and exit lane information of the intersection, the lane status indicates a traffic light signal, and the first validity determination is based on a collision risk between a second vehicle traveling a lane having the same lane status and the first vehicle.

14. The vehicle of claim 13, wherein when a result value of the first validity determination indicates a validity, the processor uses the intersection status information and the SPaT message in an application of the first vehicle.

15. The vehicle of claim 13, wherein when a result value of the first validity determination indicates an invalidity, the processor executes a low-speed traveling to prevent the collision risk.

16. The vehicle of claim 13, wherein the processor executes a second validity determination for determining whether the intersection status information and the SPaT message are valid based on sensing data acquired through the sensor, and the first vehicle enters the intersection.

17. The vehicle of claim 16, wherein the second validity determination is based on whether an actual travel status of the second vehicle acquired using the sensing data and a prediction travel status of the second vehicle predicted using the intersection status information and the SPaT message coincide with each other.

18. The vehicle of claim 16, wherein the second validity determination is based on whether a signal of a traffic light device of the intersection acquired using the sensing data and a traffic light signal predicted using the intersection status information and the SPaT message coincide with each other.

19. The vehicle of claim 13, wherein in order to execute the first validity determination, the processor executes the determination based on whether, using an array constituted by rows and columns corresponding to the entry lane information of the intersection, a first number of the array mapped to the traveling route of the first vehicle and a second number of the array mapped to an entry lane of the intersection coincide with each other.

20. The vehicle of claim 13, wherein when the first vehicle enters a preset constant distance from a center point of the intersection and does not receive the intersection status information and the SPaT message, the processor executes a low-speed traveling to prevent the collision risk.
